(19) United States
(12) Patent Application Publication
(10) Pub. No.: US 2025/0066929 A1
(43) Pub. Date: Feb. 27, 2025

(54) ELECTROCHEMICAL UPGRADING OF REDUCED CARBON PRODUCTS

(71) Applicant: Prometheus Fuels, Inc, Santa Cruz, CA (US)

(72) Inventor: Robert MCGINNIS, Santa Cruz, CA (US)

(21) Appl. No.: 18/949,204

(22) Filed: Nov. 15, 2024

Related U.S. Application Data
(63) Continuation of application No. PCT/US2023/022428, filed on May 16, 2023.
(60) Provisional application No. 63/343,018, filed on May 17, 2022.

(51) Int. Cl. C25B 3/26; C25B 1/135; C25B 9/19; C25B 9/77; C25B 11/037; C25B 13/05; C25B 15/031

(52) U.S. Cl. CPC C25B 3/26; C25B 1/135; C25B 9/19; C25B 9/77; C25B 11/037; C25B 13/05; C25B 15/031

(57) ABSTRACT

Described herein are methods for reduced carbon product generation, comprising: contacting a gas stream with an electrolyte solution, wherein said gas stream comprises carbon dioxide (CO2), thereby capturing said CO2 from said gas stream into said electrolyte solution; reducing said CO2 in said electrolyte solution to generate a first reduced carbon product; and reducing said first reduced carbon product to generate a second reduced carbon product, wherein said second reduced carbon product (e.g., upgraded RCP) comprises a greater number of carbon atoms than said first reduced carbon product.

### CROSS-REFERENCE

This application is a Continuation Application of International Application No. PCT/US2023/022428, filed May 16, 2023, which claims the benefit of U.S. Provisional Application No. 63/343,018, filed May 17, 2022, which application is incorporated herein by reference in its entirety.

### BACKGROUND

Various types of reduced carbon products may be generated from the electrochemical reduction of carbon dioxide (“CO₂”) including but not limited to alcohols, aldehydes, ketones, and linear, branched, and cyclic alkanes and alkenes. In some cases, reduced carbon products can be further reduced, such that additional carbon, hydrogen, and, in some cases, oxygen atoms are added to the reduced carbon products, along with electrons, increasing their size and energy and changing their combustion characteristics.

### SUMMARY

The present disclosure provides systems and methods for the electrochemical reduction of carbon dioxide (“CO₂”) into reduced carbon products, such as fuel, and upgrading, or further reduction, of the reduced carbon products into larger products. In some cases, the upgrading of reduced carbon products is achieved without high temperature and/or high-pressure catalysis. Recognized herein is an increased need for efficient methods of upgrading reduced carbon products into larger, reduced carbon products, which may be used as diesel or jet fuels. The methods and systems described herein may allow for the production of larger, reduced carbon products without requiring high temperature or high-pressure catalysis. This can significantly reduce the cost of producing larger reduced carbon products or fuels from CO₂.

In an aspect, provided herein is a method for reduced carbon product generation, comprising: (a) contacting a gas stream with an electrolyte solution, wherein the gas stream comprises carbon dioxide (CO₂), thereby capturing the CO₂ from the gas stream into the electrolyte solution; (b) reducing the CO₂ in the electrolyte solution to generate a first reduced carbon product; and (c) reducing a subset of the first reduced carbon product to generate a second reduced carbon product, wherein the second reduced carbon product comprises a greater number of carbon atoms than the first reduced carbon product.

In some cases, the method comprises using an electrochemical stack to reduce the CO₂ to generate the first reduced carbon product. In some cases, the method comprises using the electrochemical stack to reduce the subset of the first reduced carbon product to generate the second reduced carbon product. In some cases, the electrochemical stack further comprises a carbon nanotube (CNT) membrane. In some cases, the CNT membrane separates the first reduced carbon product from the second reduced carbon product.

In some cases, the method further comprises removing an additional subset of the first reduced carbon product from the electrochemical stack. In some cases, the method further comprises recycling at least a portion of the additional subset of the first reduced carbon product to the electrochemical stack. In some cases, the method further comprises controlling one or more parameters of the electrochemical stack to facilitate or increase generation of the second reduced carbon product in (c).

In some cases, the one or more parameters comprises a pH of the electrochemical stack. In some cases, pH of the electrochemical stack is greater than 10. In some cases, the pH of the electrochemical stack is greater than 12. In some cases, the pH of the electrochemical stack is greater than 14.

In some cases, the one or more parameters comprises a concentration of total inorganic carbon (TIC) in the electrochemical stack. In some cases, the concentration of the TIC in the electrochemical stack is greater than 0.5 mol/L (M). In some cases, the concentration of the TIC in the electrochemical stack is between about 0.5 M and 2.5 (M).

In some cases, the one or more parameters comprises a flow profile or flow rate of the electrolyte solution through the electrochemical stack. In some cases, the flow profile of the electrolyte solution comprises laminar flow. In some cases, the laminar flow has a Reynolds' number of less than 2000.

In some cases, the electrochemical stack comprises a catalyst, and wherein one or more parameters comprises a particle size of the catalyst. In some cases, the particle size of the catalyst is greater than 25 nanometers (nm). In some cases, the particle size of the catalyst is between 25 nanometers (nm) and 100 nm.

In some cases, the one or more parameters comprises a residence time of the electrolyte solution in the electrochemical stack. In some cases, the electrochemical stack comprises a catalyst.

In some cases, the one or more parameters comprise at least two of the following: (a) a pH of the electrochemical stack, (b) a concentration of total inorganic carbon (TIC) in the electrochemical stack, (c) a flow profile or flow rate of the electrolyte solution through the electrochemical stack, (d) a particle size of the catalyst, and (e) a residence time of the electrolyte solution is the electrochemical stack. In some cases, the one or more parameters comprise at least three of the following: (a) a pH of the electrochemical stack, (b) a concentration of total inorganic carbon (TIC) in the electrochemical stack, (c) a flow profile or flow rate of the electrolyte solution through the electrochemical stack, (d) a particle size of the catalyst, and (e) a residence time of the electrolyte solution is the electrochemical stack. In some cases, the one or more parameters comprise at least four of the following: (a) a pH of the electrochemical stack, (b) a concentration of total inorganic carbon (TIC) in the electrochemical stack, (c) a flow profile or flow rate of the electrolyte solution through the electrochemical stack, (d) a particle size of the catalyst, and (e) a residence time of the electrolyte solution is the electrochemical stack. In some cases, the one or more parameters comprise the following: (a) a pH of the electrochemical stack, (b) a concentration of total inorganic carbon (TIC) in the electrochemical stack, (c) a flow profile or flow rate of the electrolyte solution through the electrochemical stack, (d) a particle size of the catalyst, and (e) a residence time of the electrolyte solution is the electrochemical stack.

In some cases, (c) comprises using an additional electrochemical stack separate from the electrochemical stack to reduce the first reduced carbon product to generate the second reduced carbon product. In some cases, the further comprises: (a) controlling a first set of parameters of the electrochemical stack to facilitate or increase generation of the first reduced carbon product in the electrochemical stack, and (b) controlling a second set of parameters of the additional electrochemical stack to facilitate or increase generation of the second reduced carbon product in the additional electrochemical stack.

In some cases, the electrochemical stack comprises a first catalyst, and wherein the additional electrochemical stack comprises a second catalyst. In some cases, the first set of parameters or the second set of parameters comprise at least two of the following: (a) a pH of the electrochemical stack or the additional electrochemical stack, (b) a concentration of total inorganic carbon (TIC) in the electrochemical stack or the additional electrochemical stack, (c) a flow profile or flow rate of the electrolyte solution through the electrochemical stack or the additional electrochemical stack, (d) a particle size of the first catalyst or the second catalyst, and (e) a residence time of the electrolyte solution in the electrochemical stack or the additional electrochemical stack. In some cases, the first set of parameters or the second set of parameters comprise at least three of the following: (a) a pH of the electrochemical stack or the additional electrochemical stack, (b) a concentration of total inorganic carbon (TIC) in the electrochemical stack or the additional electrochemical stack, (c) a flow profile or flow rate of the electrolyte solution through the electrochemical stack or the additional electrochemical stack, (d) a particle size of the first catalyst or the second catalyst, and (e) a residence time of the electrolyte solution in the electrochemical stack or the additional electrochemical stack. In some cases, the first set of parameters or the second set of parameters comprise at least four of the following: (a) a pH of the electrochemical stack or the additional electrochemical stack, (b) a concentration of total inorganic carbon (TIC) in the electrochemical stack or the additional electrochemical stack, (c) a flow profile or flow rate of the electrolyte solution through the electrochemical stack or the additional electrochemical stack, (d) a particle size of the first catalyst or the second catalyst, and (e) a residence time of the electrolyte solution in the electrochemical stack or the additional electrochemical stack. In some cases, the first set of parameters or the second set of parameters comprise the following: (a) a pH of the electrochemical stack or the additional electrochemical stack, (b) a concentration of total inorganic carbon (TIC) in the electrochemical stack or the additional electrochemical stack, (c) a flow profile or flow rate of the electrolyte solution through the electrochemical stack or the additional electrochemical stack, (d) a particle size of the first catalyst or the second catalyst, and (e) a residence time of the electrolyte solution in the electrochemical stack or the additional electrochemical stack.

In some cases, the electrochemical stack is operated at a lower pH than the additional electrochemical stack. In some cases, the electrochemical stack has a lower total inorganic carbon (TIC) concentration than the additional electrochemical stack. In some cases, the electrolyte solution in the electrochemical stack has a lower Reynolds' number than the electrolyte solution in the additional electrochemical stack. In some cases, the additional electrochemical stack is taller than the electrochemical stack. In some cases, the additional electrochemical stack is wider than the electrochemical stack. In some cases, the electrochemical stack comprises a first catalyst, and wherein the additional electrochemical stack comprises a second catalyst. In some cases, a particle size of the second catalyst is larger than the first catalyst. In some cases, a residence time of the electrolyte solution in the electrochemical stack is less than a residence time of the electrolyte solution in the additional electrochemical stack.

In another aspect, provided herein is a method for producing a reduced carbon product from carbon dioxide (CO₂), comprising: (a) contacting a gas stream with an electrolyte solution, wherein the gas stream comprises CO₂, thereby capturing the CO₂ from the gas stream into the electrolyte solution; and (b) using an electrochemical stack to reduce the CO₂ in the electrolyte solution to generate a reduced carbon product, wherein one or more parameters of the electrochemical stack are selected such that the reduced carbon product has a predetermined number of carbon atoms.

In some cases, the one or more parameters comprises a pH of the electrochemical stack. In some cases, the pH of the electrochemical stack is greater than 10. In some cases, the pH of the electrochemical stack is greater than 12. In some cases, the pH of the electrochemical stack is greater than 14.

In some cases, the one or more parameters comprises a concentration of total inorganic carbon (TIC) in the electrochemical stack. In some cases, the concentration of the TIC in the electrochemical stack is greater than 0.5 mol/L (M). In some cases, the concentration of the TIC in the electrochemical stack is between about 0.5 M and 2.5 (M).

In some cases, the one or more parameters comprises a flow profile or flow rate of the electrolyte solution through the electrochemical stack. In some cases, the flow profile of the electrolyte solution comprises laminar flow. In some cases, the laminar flow has a Reynolds' number of less than 2000.

In some cases, the electrochemical stack comprises a catalyst, and wherein one or more parameters comprises a particle size of the catalyst. In some cases, the particle size of the catalyst is greater than 25 nanometers (nm). In some cases, the particle size of the catalyst is between 25 nanometers (nm) and 100 nm.

In some cases, the one or more parameters comprises a residence time of the electrolyte solution in the electrochemical stack. In some cases, the electrochemical stack comprises a catalyst.

In some cases, the one or more parameters comprise at least two of the following: (a) a pH of the electrochemical stack, (b) a concentration of total inorganic carbon (TIC) in the electrochemical stack, (c) a flow profile or flow rate of the electrolyte solution through the electrochemical stack, (d) a particle size of the catalyst, and (e) a residence time of the electrolyte solution is the electrochemical stack. In some cases, the one or more parameters comprise at least three of the following: (a) a pH of the electrochemical stack, (b) a concentration of total inorganic carbon (TIC) in the electrochemical stack, (c) a flow profile or flow rate of the electrolyte solution through the electrochemical stack, (d) a particle size of the catalyst, and (e) a residence time of the electrolyte solution is the electrochemical stack. In some cases, the one or more parameters comprise at least four of the following: (a) a pH of the electrochemical stack, (b) a concentration of total inorganic carbon (TIC) in the electrochemical stack, (c) a flow profile or flow rate of the electrolyte solution through the electrochemical stack, (d) a particle size of the catalyst, and (e) a residence time of the electrolyte solution is the electrochemical stack. In some cases, the one or more parameters comprise the following: (a) a pH of the electrochemical stack, (b) a concentration of total inorganic carbon (TIC) in the electrochemical stack, (c) a flow profile or flow rate of the electrolyte solution through the electrochemical stack, (d) a particle size of the catalyst, and (e) a residence time of the electrolyte solution is the electrochemical stack.

In another aspect, provided herein is a system for producing a reduced carbon product from carbon dioxide (CO₂), comprising: (a) a CO₂ capture unit configured to contact a gas stream comprising the CO₂ with an electrolyte solution, thereby capturing the CO₂ from the gas stream into the electrolyte solution; (b) a first electrochemical stack in fluidic communication with the CO₂ capture unit, wherein the first electrochemical stack is configured to reduce the CO₂ in the electrolyte solution to generate a first reduced carbon product; and (c) a second electrochemical stack in fluidic communication with the first electrochemical stack, wherein the second electrochemical stack is configured to reduce at least a portion of the first reduced carbon product to generate a second reduced carbon product, and wherein the second reduced carbon product comprises a greater number of carbon atoms than the first reduced carbon product.

In some cases, the second electrochemical stack is taller than the first electrochemical stack. In some cases, the second electrochemical stack is wider than the first electrochemical stack. In some cases, the first electrochemical stack or the second electrochemical stack comprise a carbon nanotube (CNT) membrane. In some cases, the CNT membrane is configured to separate one or more reduced carbon products based on size. In some cases, the system further comprises a separation unit located between the first electrochemical stack and the second electrochemical stack. In some cases, the separation unit is configured to separate the first reduced carbon product from the electrolyte solution. In some cases, the separation unit is configured to direct the separated electrolyte solution to the CO₂ capture unit. In some cases, the separation unit comprises a carbon nanotube (CNT) membrane. In some cases, the system further comprises a split unit located downstream of the second electrochemical stack. In some cases, the split unit is configured to separate one or more reduced carbon products based on size, thereby obtaining a smaller reduced carbon product stream and a larger reduced carbon product stream. In some cases, the split unit is configured to direct the smaller reduced carbon product stream to the second electrochemical stack for further upgrading. In some cases, the split unit comprises a carbon nanotube (CNT) membrane.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein) of which:

FIG. 1 illustrates a schematic diagram of a method for upgrading reduced carbon products using an upgrade stack, in accordance with some embodiments.

FIG. 2 illustrates an additional schematic diagram of a method for upgrading reduced carbon products in the absence of an upgrade stack, in accordance with some embodiments.

FIG. 3 illustrates a schematic of a computer system as utilized for the systems and methods described herein, in accordance with embodiments.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than.” “less than,” or “less than or equal to” applies to each of the numerical values in that series of numerical values. For example, less than or equal to 3, 2, or 1 is equivalent to less than or equal to 3, less than or equal to 2, or less than or equal to 1.

As used herein, the term “about” generally refers to within #1%, 5%, of 10% of a value. For example, if it is stated, “a temperature of about 100 degrees Celsius”, it can be implied that the temperature may be from 90° C., to 110° C.

As used in this specification and the appended claims, the singular forms “a.” “an,” and “the” include plural referents unless the content clearly dictates otherwise. It should also be noted that the term “or” is generally employed in its sense including “and/or” unless the content clearly dictates otherwise.

The terms “C1+” and “C1+ compound.” as used herein, generally refer to a compound comprising one or more carbon atoms, e.g., one carbon atom (C1), two carbon atoms (C2), etc. C1+ compounds include, without limitation, alkanes (e.g., methane, CH₄), alkenes (e.g., ethylene, C₂H₂), alkynes and aromatics containing two or more carbon atoms. In some cases, C1′+ compounds include aldehydes, ketones, esters and carboxylic acids. Examples of C1+ compounds include, without limitation, methane, ethane, ethylene, acetylene, propane, propene, butane, butylene, etc. A C1+ compound may also be referred to as a reduced carbon product (RCP) or reduced carbon material, as used herein

The term “unit.” as used herein, generally refers to a unit operation, which is a basic operation in a process. Unit operations may involve a physical change or chemical transformation, such as, for example, separation, crystallization, evaporation, filtration, polymerization, isomerization, transformation, and other reactions. A given process may require one or a plurality of unit operations to obtain the desired product(s) from a starting material(s), or feedstock(s).

The term “carbon-containing material,” as used herein, generally refers to any material comprising at least one carbon atom. In some examples, a carbon-containing material is carbon monoxide (CO), carbon dioxide (CO₂), or a mixture of CO and CO₂. The carbon-containing material may be a material derived from CO and/or CO₂, such as bicarbonate or bicarbonate ions. Provided herein are systems, devices, and methods for the electrochemical reduction of CO₂ into reduced carbon products and the upgrading of reduced carbon products into larger products. Carbon species that may be produced from the electrochemical reduction (i.e., adding of electrical energy in the form of chemical bonds) of CO₂ are many, including carbon monoxide, hydrocarbon gases, alcohols, aldehydes, and organic acids. Additionally, these reduced carbon products can be upgraded into longer chain hydrocarbons, many of which have a high a potential for conversion to useful products, including transportation fuels and polymers. An RCP may be upgraded into a longer chain hydrocarbon via chemical reaction, electrochemical reduction, or a combination thereof.

An electrochemical reduction system for the conversion of CO₂ into other chemicals may comprise various components that may be necessary for the reduction of CO₂. In some instances, an electrochemical reduction system may be referred to as a chemical conversion system herein. Components may include cathodes, anodes, contactors, extractors, pumps, vapor-liquid separators (e.g., micro- or nanostructured membranes), and ion exchange membranes. In some embodiments, an electrochemical reduction system comprises a cathode and an anode. In some embodiments, an electrochemical reduction system comprises a cathode, an anode, and an ion-exchange membrane. In some embodiments, an electrochemical reduction system is referred to as a stack. In some embodiments, the cathode comprises a catalyst. In some instances, some components may be included or excluded from a chemical reduction system depending upon the preferred embodiment of the device. In some instances, a chemical reduction system may be a single, stand-alone, or fully integrated system that performs all processes in the electrochemical reduction of CO₂. In other instances, an electrochemical reduction system may comprise at least two or more operatively linked unit operations that collectively perform the necessary processes in the electrochemical reduction of CO₂.

An electrochemical reduction system may comprise a cathode, an anode and an electrolyte solution that collectively provide the necessary components for the reduction of carbon dioxide to other chemical species. The electrolyte may comprise an aqueous salt solution that is composed with an optimal ionic strength and pH for the electrochemical reduction of CO or CO₂. An electrolyte may comprise an aqueous salt solution comprising bicarbonate ions. In some instances, an electrolyte may comprise an aqueous solution of sodium bicarbonate or potassium bicarbonate. In some instances, bicarbonate ions may dissociate in the presence of one or more catalysts to produce CO or CO₂ molecules for a reduction reaction. The dissolution of CO or CO₂ into the electrolyte solution may regenerate or maintain the optimal concentration of bicarbonate ions.

An electrochemical reduction system may be configured to operate at an optimal voltage for the reduction of CO or CO₂ to reduced products. An electrochemical reduction system may be arranged in a stack or series configuration to tailor the system voltage to an optimal value. An electrochemical reduction system may have an operating voltage of about 0.1 volts (V), 0.2V, 0.3V, 0.4V, 0.5V, 0.75V, 1.0V, 2.0V, 3.0V, 4.0V, 5.0V, 10 V, 15V, or about 20V. An electrochemical reduction system may have an operating voltage of at least about 0.1 volts (V), 0.2V, 0.3V, 0.4V, 0.5V, 0.75V, 1.0V, 2.0V, 3.0V, 4.0V, 5.0V, 10 V, 15V, or about 20V or more. An electrochemical reduction system may have an operating voltage of no more than about 20V, 15V, 10V, 5.0V, 4.0V, 3.0V, 2.0V, 1.0V, 0.75V, 0.5V, 0.4V, 0.3V, 0.2V, or about 0.1V or less.

An anode may comprise an elemental metal such as nickel, tin, or gold. An anode may comprise a wire mesh, metal foam or other permeable structure of the chosen anode material. An anode material may be in operative contact with an anion exchange membrane material or another physical separator that prevents contact with the cathode.

A cathode may comprise any appropriate material. In some embodiments, a cathode may comprise a catalyst. In some embodiments the cathode comprises a membrane comprising the catalyst. In some embodiments, the catalyst is used to reduce the carbon-containing material in the electrolyte. In some instances, a cathode may comprise copper nanoparticles and/or N-doped carbon nanomaterials. In some instances, a cathode may comprise a micro- or nanostructured membrane material. In some instances, a cathode may comprise one or more catalysts for the electrochemical reduction of CO or CO₂ or other chemical reactions. A cathode material may be in operative contact with an anion exchange membrane material or another physical separator that prevents contact with the cathode. In some instances, the distance between the cathode and anode may be minimized to reduce resistance. In some instances, forced convective flow of electrolyte between the electrodes may further reduce electrical resistance and/or may allow for greater distance between the electrodes. In some instances, the electrodes may be in different housings. In some instances, the anode and cathode may have a minimal distance with an ion selective membrane between them. In some instances, no ion selective membrane may be used.

An electrochemical reduction system may comprise one or more extractor units. An extractor unit may comprise any unit operation or separation unit that selectively separates one or more chemical species from a feed stream. In some instances, an extractor may comprise a membrane separator. In some instances, an extractor may comprise a micro- or nanostructured membrane. In some instances, an extractor may extract one or more chemical species derived from the reduction of carbon dioxide. In some instances, an extractor may extract one or more chemical species derived from the reduction of CO or CO₂ from an electrolyte solution. In other instances, an extractor may separate one or more chemical species derived from the subsequent reaction of carbon dioxide electrochemical reduction products.

A micro- or nanostructured membrane may be utilized to perform a selective separation of one or more chemical species from a mixture comprising more than one chemical species. A micro- or nanostructured membrane may comprise one or more microscale or nanoscale materials features (e.g., including positive features, such as microscale or nanoscale structures, and/or negative features, such as microscale and nanoscale pores or microscale and nanoscale depressions). In some instances, a membrane may comprise carbon nanotubes, carbon nanospheres, carbon nano-onions, graphene-like materials, or pyrolyzed porous carbon materials. A micro- or nanostructured material embedded in a substrate or material may create pores within the structured membrane. The pores may permit the selective passage of certain chemical species. Other substrates or materials in the membrane may be selected for material properties including rigidity, strength, and electrical conductivity. A membrane may comprise a material with a characterized porous structure. Materials may include nanopores, mesopores, and micropores. In some instances, nanopores may be characterized as having an average pore size of about 2 nm or less. In some instances, mesopores may be characterized as having an average pore size of between about 2 nm and about 20 nm. In some instances, micropores may be characterized as having an average pore size of about 20 nm or more. A membrane may comprise structures with pore sizes across a range of pores sizes (e.g., nanopores and mesopores). A membrane may comprise structures with pores sizes from within a particular classification of pores sizes (e.g., only mesopores). Pores may have circular, oval, non-circular or irregular pore shapes or pore cross-section profiles. A pore size may be characterized as an average characteristic cross-sectional dimension (e.g., pore diameter or cross-sectional area). A membrane may comprise pores (e.g., micropores or nanopores) with an average cross-sectional dimension of at least about 0.5 nm, 1 nm, 5 nm, 10 nm, 15 nm, 20 nm, 30 nm, 40 nm, 50 nm, 100 nm, 250 nm, 500 nm, 1 micron (μm), or at least about 5 μm or more. A membrane may comprise pores with an average cross-sectional dimension of no more than about 5 μm, 1 μm, 500 nm, 250 nm, 100 nm, 50 nm, 40 nm, 30 nm, 20 nm, 15 nm, 10 nm, 5 nm, 1 nm, 0.5 nm or less.

A membrane comprising a micro- or nanostructured material may permit mass transport of one or more chemical species across the membrane. A membrane comprising a micro- or nanostructured material may be selective for particular species. In some instances, a membrane comprising micro- or nanostructured materials may selectively transfer CO or CO₂ from a gas stream. In some instances, a membrane comprising micro- or nanostructured materials may selectively transfer gaseous ethylene or ethanol from a gas mixture. In some instances, a membrane comprising micro- or nanostructured materials may selectively transfer hydrocarbons from an aqueous liquid mixture. A membrane comprising a micro- or nanostructured material may transfer particular chemical species by diffusive or convective mass transport. In some instances, mass transfer may be enhanced by the application of an external force or field. In particular instances, mass transfer may be driven or enhanced by the application of a magnetic or electrical field. In other instances, mass transfer may be driven by a pressure gradient (e.g., pulling a vacuum on one side of the membrane). In some instances, the selectivity of a membrane can be reversed by reversing an applied field or force. In other instances, a membrane may have a unidirectional or invariant mass transfer selectivity.

An electrochemical reduction system may comprise one or more contactor units. A contactor unit may comprise any unit operation or separation unit that selectively separates one or more chemical species from a feed stream. In some instances, a contactor may comprise a gas adsorption column. In other instances, a contactor may comprise packing to increase a liquid solutions surface area and a fan to increase gas passage at the liquid interface. Such contactors may share design features with cooling towers. In other instances, an extractor may comprise a membrane separator. In some instances, an extractor may comprise a micro- or nanostructured membrane. In some instances, a contactor may extract one or more chemical species from a feed stream. In some instances, a contactor may extract carbon dioxide from a feed stream. In some instances, a contactor may separate CO or CO₂ from a feed stream and dissolve the CO or CO₂ in an electrolyte solution. In some cases, a feed stream may be air. In some cases, the feed stream may be filtered prior to use. Such filtering may in some cases remove particulate matter and/or volatile organic materials and/or undesired materials of various kinds. The uptake of CO or CO₂ in a gas contactor may be enhanced by the presence of hydroxide ions generated within the electrochemical reduction system.

In some embodiments, the electrochemical reduction system comprises a voltage source configured to supply voltage to the electrochemical reduction system. In some embodiments, a carbon containing material (e.g., bicarbonate) is reduced to a C1+ product in the electrochemical reduction system while a voltage is applied

Described herein are various chemical products and reaction mixtures generated via the electrochemical reduction of CO₂ captured from an input air stream. Electrochemical reduction comprises the addition of electrical energy (e.g., voltage) in the form of chemical bonds. The electrochemical reduction may produce carbon species comprising of one or more members selected from the group consisting of carbon monoxide, hydrocarbon gases, alkanes, alkenes, alcohols, aldehydes, organic acids, and other organic molecules of varying chain lengths. In some embodiments, electrochemical reduction may produce carbon species comprising a chain length of 1 to 40 carbons. The products of the described electrochemical reduction systems may be further processed into useful products, including transportation fuels and polymers.

Described herein are various chemical products and reaction mixtures generated via the electrochemical reduction of CO₂ derived from a gas source. The gas source may be the atmosphere. The gas source may be any CO₂-bearing gas stream. Chemical products may include any process stream that is exported from a chemical processing system or any process stream that undergoes no further reactive processes. A reaction mixture may include any process mixture, reagent, or compound within the confines of a chemical reactor, reactor system, or in a process stream between chemical reactors or reactor systems. The chemical products and reaction mixtures of the systems and methods described herein may include organic molecules where one or more of the constituent carbon atoms are derived from CO₂. In some instances, a chemical product or reaction mixture may contain only carbon atoms derived from CO₂. In other instances, a chemical product may contain carbon atoms derived from CO₂ and carbon atoms derived from other sources (e.g, bio fuels). In some instances, chemical products of the systems and methods described herein may have a distinct carbon isotope signature that is consistent with the carbon isotope signature of CO₂ derived from the atmosphere. In some instances, chemical products and reaction mixtures of the systems and methods described herein may have a distinct carbon isotope signature that is consistent with the carbon isotope signature of CO₂ derived from a non-atmospheric source such as the combustion of fossil fuels. The carbon isotope signature of a chemical product or reaction mixture may be measured by an isotopic ratio of ¹⁴C:¹²C or ¹³C:¹²C. In some instances, the isotopic signature of a chemical product or reaction mixture may be measured as a per mille difference between the natural isotopic ratio of carbon and the measured isotopic ratio. A per mille difference between the natural isotopic ratio of carbon and the measured isotopic ratio for ¹⁴C, Δ¹⁴C, may be calculated as:

$${Δ}^{14} C = [ \frac{{[ \frac{{14}^{} C}{{12}^{} C} ]}_{measured}}{{[ \frac{{14}^{} C}{{12}^{} C} ]}_{standard}} - 1 ] \times 1000$$

$${Δ}^{14} C = [ \frac{{[ \frac{{14}^{} C}{{12}^{} C} ]}_{measured}}{{[ \frac{{14}^{} C}{{12}^{} C} ]}_{standard}} - 1 ] \times 1000$$

A per mille difference between the natural isotopic ratio of carbon and the measured isotopic ratio for ¹³C, Δ¹³C, may be calculated as:

$${Δ}^{13} C = [ \frac{{[ \frac{{13}^{} C}{{12}^{} C} ]}_{measured}}{{[ \frac{{13}^{} C}{{12}^{} C} ]}_{standard}} - 1 ] \times 1000$$

$${Δ}^{13} C = [ \frac{{[ \frac{{13}^{} C}{{12}^{} C} ]}_{measured}}{{[ \frac{{13}^{} C}{{12}^{} C} ]}_{standard}} - 1 ] \times 1000$$

A chemical product or reaction mixture may have a Δ¹⁴C of about −100 parts per thousand (%ₒ), −10%ₒ, 0%ₒ, 5%ₒ, 10%ₒ, 20%ₒ, 30%ₒ, 40%ₒ, 45%ₒ, 50%ₒ or about 100%ₒ. A chemical product or reaction mixture may have a Δ¹⁴C, of at least about −100%ₒ, −10%ₒ, 0%ₒ, 5% 6, 10%ₒ, 20%ₒ, 30%ₒ, 40%ₒ, 45%ₒ, 50%ₒ or at least about 100%ₒ or more. A chemical product or reaction mixture may have a Δ¹⁴C of at most about −100%ₒ, −10% 6, 0%ₒ, 5%ₒ, 10%ₒ, 20%ₒ, 30%ₒ, 40%ₒ, 45%ₒ, 50%ₒ or at most about 100%ₒ or less. A chemical product or reaction mixture may have a Δ¹³C of about −40%ₒ, −35%ₒ, −30%ₒ, −28%ₒ, −26%ₒ, −24%ₒ, −22%ₒ, −20%ₒ, −15%ₒ, −10%ₒ, −8%ₒ, or about −5%ₒ. A chemical product or reaction mixture may have a Δ¹³C of at least about −40%ₒ, −35%ₒ, −30%ₒ, −28%ₒ, −26%ₒ, −24%ₒ, −22%ₒ, −20%, −15%ₒ, −10%ₒ, −8%ₒ, or at least about −5%ₒ or more. A chemical product or reaction mixture may have a Δ¹³C of at most about −40%ₒ, −35%ₒ, −30%ₒ, −28%ₒ, −26%ₒ, −24%ₒ, −22%ₒ, −20%ₒ, −15%ₒ, −10%ₒ, −8%ₒ, or at most about −5%ₒ or less. Provided herein are products or reaction mixtures comprising a composition that has a Δ¹³C of greater than −25%ₒ. In one example, the Δ¹³C may correspond to that of the ambient temperature from which CO₂ is captured (e.g., −8%ₒ). Such Δ¹³C may be distinct from the isotopic signature of products derived from, for example, fossil-based fuel or bio (e.g., plant-based) fuel. In plant-based fuel, ¹³C levels are less than that of the atmosphere, and Δ¹³C may be −25%ₒ. In another example, in fossil fuel (e.g., from oil, coal, etc.), the Δ¹³C may be even less than plant-based fuel, i.e., less than −25%ₒ. Alternatively, or in addition, products or reaction mixtures described herein may comprise a composition that does not have detectable sulfur, metals, and/or aromatics. Detectable levels may refer to, in one example, a composition of at most an order of magnitude of 1%, 0.1%, 0.01%, 0.001%, 0.0001%, 0.00001%, or less by weight. The products or reaction mixtures of the present disclosure may comprise a hydrocarbon mixture comprising C1+ products.

A chemical product or reaction mixture may include gaseous, liquid, or solid substances. Chemical products and reaction mixtures may include one or more organic compounds. Chemical products and reaction mixtures may be miscible or immiscible in water. Chemical products and reaction mixtures may be polar or nonpolar. Chemical products and reaction mixtures may be acidic, basic, or neutral. Organic compounds may include alkanes, alkenes, alkynes, cycloalkanes, cycloalkenes, cycloalkynes, substituted alkanes, substituted alkenes, substituted alkynes, alcohols, esters, carboxylic acids, ethers, amines, amides, aromatics, heteroaromatics, sulfides, sulfones, sulfates, thiols, aldehydes, ketones, amides, and halogenated compounds. Chemical products and reaction mixtures may include branched or linear compounds. Chemical products and reaction mixtures may comprise oxygen, methane, ethane, ethylene, propane, butane, hexanes, octanes, decanes, carbon monoxide, methanol, ethanol, propanol, butanol, hexanol, octanol, and formate. Chemical products and reaction mixtures may include organometallic compounds. Chemical products and reaction mixtures of the present disclosure may include compounds intended for consumer use or industrial use, such as fuels, solvents, additives, polymers, food additives, food supplements, pharmaceuticals, fertilizers, agricultural chemicals, coatings, lubricants, and building materials. Chemical products and reaction mixtures of the present disclosure may comprise a precursor, component, substituent, or substrate for a product produced by further processing.

An organic compound (e.g., C1+ product) of the present disclosure may comprise one or more carbon atoms. In some instances, an organic compound may comprise about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, or about 70 carbon atoms. In some instances, an organic compound may comprise at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, or about 70 or more carbon atoms. In some instances, an organic compound may comprise no more than about 70, 65, 60, 55, 50, 45, 40, 35, 30, 29, 28, 27, 26, 25, 24, 23, 22, 21, 20, 19, 18, 17, 16, 15, 14, 13, 12, 11, 10, 9, 8, 7, 6, 5, 4, 3, 2 or less carbon atoms. An organic compound of the present disclosure may comprise one or more carbon atoms derived from CO or CO₂. In some instances, an organic compound may comprise about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, or about 70 carbon atoms that are derived from CO or CO₂. In some instances, an organic compound may comprise at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, or about 70 or more carbon atoms that are derived from CO or CO₂. In some instances, an organic compound may comprise no more than about 70, 65, 60, 55, 50, 45, 40, 35, 30, 29, 28, 27, 26, 25, 24, 23, 22, 21, 20, 19, 18, 17, 16, 15, 14, 13, 12, 11, 10, 9, 8, 7, 6, 5, 4, 3, 2 or less carbon atoms that are derived from CO or CO₂.

In some embodiments, a C1+ product may comprise about 1 carbon atom to about 40 carbon atoms. In some embodiments, a C1+ product may comprise about 1 carbon atom to about 30 carbon atoms. In some embodiments, a C1+ product may comprise about 1 carbon atom to about 20 carbon atoms. In some embodiments, a C1+ product may comprise about 10 carbon atom to about 20 carbon atoms. In some embodiments, a C1+ product may comprise about 12 carbon atom to about 20 carbon atoms.

A chemical product or reaction mixture of the present disclosure may comprise more than one chemical species. A chemical product or reaction mixture may be a mixture of about 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95 or about 100 detectable chemical compounds. A chemical product or reaction mixture may be a mixture of at least about 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95 or about 100 or more detectable chemical compounds. A chemical product or reaction mixture may be a mixture of no more than about 100, 95, 90, 85, 80, 75, 70, 65, 60, 55, 50, 45, 40, 35, 30, 29, 28, 27, 26, 25, 24, 23, 22, 21, 20, 19, 18, 17, 16, 15, 14, 13, 12, 11, 10, 9, 8, 7, 6, 5, 4, or no more than about 3 or less detectable chemical compounds.

A chemical product or reaction mixture of the present disclosure may comprise a particular compound at a particular weight percentage or molar percentage of the total chemical product or reaction mixture. For example, a particular chemical product may include at least about 50 wt % ethanol. In another example, a particular chemical product may include no more than about 1 wt % water. In some instances, at least about 10%, 15%, 20%, 25%, 30%, 35%, 40%, 45%, 50%, 55%, 60%, 65%, 70%, 75%, 80%, 85%, 90%, 95%, 96%, 97%, 98%, 99% or more of a chemical product or reaction mixture may be a specific chemical compound on a weight or molar basis. In some instances, no more than about 99%, 98%, 97%, 96%, 95%, 90%, 85%, 80%, 75%, 70%, 65%, 60%, 55%, 50%, 45%, 40%, 35%, 30%, 25%, 20%, 15%, or no more than about 10% or less of a chemical product or reaction mixture be a specific chemical compound on a weight or molar basis.

A chemical product or reaction mixture of the present disclosure may include compounds within a particular range of molecular weights or carbon numbers. In some instances, at least about 10%, 15%, 20%, 25%, 30%, 35%, 40%, 45%, 50%, 55%, 60%, 65%, 70%, 75%, 80%, 85%, 90%, 95%, 96%, 97%, 98%, 99% or more of a chemical product or reaction mixture may include compounds within a particular molecular weight range or carbon number range. In some instances, no more than about 99%, 98%, 97%, 96%, 95%, 90%, 85%, 80%, 75%, 70%, 65%, 60%, 55%, 50%, 45%, 40%, 35%, 30%, 25%, 20%, 15%, or no more than about 10% or less of a chemical product or reaction mixture may include compounds within a particular molecular weight range or carbon number range. A chemical product or reaction mixture may include compounds within a molecular weight range from about 15 g/mol to about 30 g/mol, about 15 g/mol to about 60 g/mol, about 15 g/mol to about 100 g/mol, about 15 g/mol to about 200 g/mol, about 15 g/mol to about 400 g/mol, about 15 g/mol to about 600 g/mol, about 15 g/mol to about 1000 g/mol, about 30 g/mol to about 60) g/mol, about 30 g/mol to about 100 g/mol, about 30 g/mol to about 200 g/mol, about 30 g/mol to about 400 g/mol, about 30 g/mol to about 600 g/mol, about 30 g/mol to about 1000 g/mol, about 60 g/mol to about 100 g/mol, about 60 g/mol to about 200 g/mol, about 60) g/mol to about 400 g/mol, about 60 g/mol to about 600 g/mol, about 60 g/mol to about 1000 g/mol, about 100 g/mol to about 200 g/mol, about 100 g/mol to about 400 g/mol, about 100 g/mol to about 600 g/mol, about 100 g/mol to about 1000 g/mol, about 200 g/mol to about 400 g/mol, about 200 g/mol to about 600 g/mol, about 200 g/mol to about 1000 g/mol, about 400 g/mol to about 600 g/mol, about 30 g/mol to about 1000 g/mol, about 30 g/mol to about 100 g/mol, about 30 g/mol to about 200 g/mol, about 30 g/mol to about 400 g/mol, about 30 g/mol to about 600 g/mol, about 400 g/mol to about 1000 g/mol, or about 600 g/mol to about 1000 g/mol. A chemical product or reaction mixture may include compounds within a carbon number range from about C1 to about C2, about C1 to about C3, about C1 to about C4, about C1 to about C5, about C1 to about C6, about C1 to about C8, about C1 to about C10, about C1 to about C20, about C1 to about C30, about C1 to about C40, about C2 to about C3, about C2 to about C4, about C2 to about C5, about C2 to about C6, about C2 to about C8, about C2 to about C10, about C2 to about C20, about C2 to about C30, about C2 to about C40, about C3 to about C4, about C3 to about C5, about C3 to about C6, about C3 to about C8, about C3 to about C10, about C3 to about C20, about C3 to about C30, about C3 to about C40), about C4 to about C5, about C4 to about C6, about C4 to about C8, about C4 to about C10, about C4 to about C20, about C4 to about C30, about C4 to about C40, about C5 to about C6, about C5 to about C8, about C5 to about C10, about C5 to about C20, about C5 to about C30, about C5 to about C40), about C6 to about C8, about C6 to about C10, about C6 to about C20, about C6 to about C30, about C6 to about C40, about C8 to about C10, about C8 to about C20, about C8 to about C30, about C8 to about C40, about C10 to about C20, about C10 to about C30, about C10 to about C40), about C20 to about C30, about C20 to about C40, or about C30 to about C40.

A chemical product or reaction mixture of the present disclosure may comprise one or more impurities. Impurities may derive from reactant streams, reactor contaminants, breakdown or decomposition products of produced organic compounds, catalyst compounds, or side reactions in the electrochemical reduction system or other chemical conversion systems described herein. A chemical product or reaction mixture may comprise one or more organic impurities such as formate or higher molecular weight alcohols. A chemical product or reaction mixture may include carbon or non-carbon nanomaterial impurities. A chemical product or reaction mixture may comprise one or more inorganic impurities derived from sources such as catalyst degradation or leaching and corrosion of processing equipment. An inorganic impurity may comprise sodium, magnesium, potassium, calcium, titanium, vanadium, chromium, manganese, iron, cobalt, nickel, copper, zinc, aluminum, silicon, yttrium, zirconium, niobium, molybdenum, ruthenium, rhodium, palladium, silver, cadmium, indium, tin, antimony, tantalum, tungsten, osmium, platinum, gold, mercury, and lead. Inorganic impurities may be present in oxidized or reduced oxidation states. Inorganic impurities may be present in the form of organometallic complexes. An impurity in a chemical product or reaction mixture may be detectable by any common analysis technique such as gas or liquid chromatography, mass spectrometry. IR or UV-Vis spectroscopy. Raman spectroscopy, X-ray photoelectron spectroscopy, X-ray diffraction, or other methods. One or more impurities may be detectable at an amount of at least about 1 part per billion (ppb), 5 ppb, 10 ppb, 50 ppb, 100 ppb, 250 ppb, 500 ppb, 750 ppb, 1 part per million (ppm), 5 ppm, 10 ppm, 50 ppm, 100 ppm or more. One or more impurities may be detectable at an amount of no more than about 100 ppm, 50 ppm, 10 ppm, 5 ppm, 1 ppm, 750) ppb, 500 ppb, 250 ppb, 100 ppb, 50 ppb, 10 ppb, 5 ppb, or no more than about 1 ppb or less.

A chemical product may have a particular level of purity. In some instances, a chemical product may have sufficient purity to achieve a particular grade or standard. A chemical product may be ACS grade, reagent grade, USP grade, NF grade, laboratory grade, purified grade or technical grade. A chemical product may have a purity that exceeds an azeotropic composition, e.g., >95% ethanol. A gaseous chemical product described herein may have a purity rating of about N1.0, N2.0, N3.0, N4.0, N5.0, N6.0 or greater. A chemical product may achieve a purity level according to a defined international standard. E.g. the ASTM D-1152/97 standard for methanol purity.

In some instances, a chemical product or reaction mixture from an electrochemical reduction system may have no detectable amount of certain impurities. In some instances, a chemical product or reaction mixture may have no detectable amount of biological molecules or derivatives thereof. A chemical product or reaction mixture may contain no detectable amount of lipids, saccharides, proteins, nucleic acids, amino acids, spores, bacteria, viruses, protozoa, fungi, animal or plant cells, or any component thereof.

An electrochemical reduction system may capture CO₂ and convert the CO₂ into a reduced carbon product. In an example, a system may be introduced to a stream of air comprising CO₂. In some examples, the input air stream comprising CO₂ may interact with an electrolyte solution. In some embodiments, the electrolyte solution comprises water. In some embodiments, the interaction of the input air stream comprising CO₂ and electrolyte solution takes place in a contactor. In some cases, interaction of the input air stream comprising CO₂ with the electrolyte solution may result in the capture of the CO₂ in the electrolyte. In some examples, the capture of CO₂ may occur as adsorption of the CO₂ onto the electrolyte or absorption of the CO₂ into the electrolyte. In some examples, the capture of CO₂ may occur as a physical interaction between CO₂ and the electrolyte (e.g., electrostatic interaction, adsorption, absorption). In some examples, capture of CO₂ may occur as a chemical interaction between CO₂ and the electrolyte. In some examples, captured CO₂ molecule may be in the form of a bicarbonate ion. For example, an air stream comprising CO₂ may interact with water to yield carbonic acid which may further dissociate in water to a bicarbonate ion and a hydronium ion (e.g., H⁺, H₃O⁺, or proton), as shown in the following reaction scheme:

CO₂+H₂O→H₂CO₃→HCO₃⁻+H⁺.

In such examples, generation of a bicarbonate ion and hydronium ion may decrease the pH (e.g., increase acidity) of the electrolyte solution. In some embodiments, CO₂ may be transported to a separate chamber or compartment while captured in electrolyte solution. In some embodiments, the CO₂ is reduced in this separate chamber. In some examples, a captured CO₂ molecule (e.g., bicarbonate ion) may be directly reduced in the presence of voltage to yield a reduced carbon product. In some instances, a captured CO₂ may not require release (e.g., desorption) from the captured CO₂ material prior to reduction into a reduced carbon product. For example, a captured CO₂ may be a bicarbonate ion, and the bicarbonate ion may directly be reduced to a reduced carbon product without an additional step requiring desorption of CO₂ from the bicarbonate ion. In an example, captured CO₂ in the form of bicarbonate may be reduced to ethanol in the presence of a voltage according to the following reaction scheme:

2HCO₃⁻+9H⁺+9e⁻→CH₃CH₂OH+5OH⁻.

A reduced carbon product may comprise an alcohol, aldehyde, alkene, alkane, acid, ketone, or combination thereof. An alcohol may comprise methanol, ethanol, propanol, isopropanol, butanol, isobutanol, tertbutanol, pentanol, isopentanol, hexanol, isohexanol, or any other straight or branched alcohol. An aldehyde may comprise methanal, ethanal, propanal, isopropanal, butanal, isobutanal, or any other straight or branched aldehyde. An alkene or alkene may be a straight-chain or branched alkene or alkane. In some embodiments, an alkene or alkane comprises an alkyl chain that is at least 1 carbon, 2 carbons, 3 carbons, 4 carbons, 5 carbons, 6 carbons, 7 carbons, 8 carbons, 9 carbons, 10 carbons, 11 carbons, 12 carbons, 13 carbons, 14 carbons, 15 carbons, 16 carbons, 17 carbons, 18 carbons, 19 carbons, 20 carbons, 30 carbons, 40 carbons, or more in length. In some embodiments, a reduced carbon product (e.g., RCP) may further be reduced in the presence of a voltage and/or electrolyte to form additional reduced carbon products (e.g., an upgraded RCP). In some embodiments, a RCP comprising an amine, hydride, alkyne, alkene, or cyclic functional groups may be further converted to an upgraded RCP no longer comprising one or more of the original functional groups.

In some embodiments, the electrochemical system is configured to produce alkanes, alkenes, or a combination thereof. In some embodiments, the electrochemical system produces alkanes, alkenes, alcohols (e.g., compounds comprising one or more hydroxyl groups), ketones, aldehydes, or a combination thereof. In some instances, aldehydes, ketones, and alcohols may undergo secondary reactions (e.g., further reactions) to yield upgraded RCPs.

In some embodiments, the conversion of CO₂ to ethanol and hydroxide ions is according to the following chemical reaction, where CO₂ and HCO₃⁻ are in equilibrium within the solution:

2CO₂+9H₂O+12e−→C₂H₅OH+12OH−.

In some examples, generation of hydroxide ions raises the pH of the solution (e.g., decreases acidity or increases basicity). In some embodiments, applying a voltage to a captured CO₂ solution may convert at least about 40%, 50%, 60%, 70%, 80%, 90%, 95%, 98%, 99%, or 100% of the captured CO₂ into a reduced carbon product.

An electrochemical conversion system may comprise one or more unit operations for separations. Separation unit operations may include distillation columns, reactive distillation columns, gas absorption columns, stripping columns, additional catalysis operations, such as with catalyst packed columns, flash tanks, humidifiers, leaching units, liquid-liquid extraction units, dryers, adsorption systems, ion-exchange columns, membrane separation units, filtration units, sedimentation units, and crystallization units. In some embodiments, a separation unit includes gas adsorption columns. In some embodiments, separation unit includes adsorption systems. In some embodiments, separation units include membranes. A chemical conversion system may comprise one or more unit operations for heat transfer. Heat transfer unit operations may include mantle heaters, cartridge heaters, tape heaters, pad heaters, resistive heaters, radiative heaters, fan heaters, shell-and-tube heat exchangers, plate-type heat exchangers, extended-surface heat exchangers, scraped-surface heat exchangers, condensers, vaporizers, and evaporators. A chemical conversion system may comprise one or more unit operations for fluid transfer. Fluid transfer devices may include piping, tubing, fittings, valves, pumps, fans, blowers, compressors, stirrers, agitators, and blenders. Pumping equipment may be operated at pressures above atmospheric pressure or used to draw a vacuum. A chemical conversion system may comprise one or more chemical reaction units aside from an electrochemical reduction reactor. Chemical reaction units may include plug flow reactors, continuous-stirred tank reactors, packed bed columns, fluidized bed reactors, and batch reactors. Chemical reactors may be utilized for various upgrading and conversions including dehydrogenation, hydrogenation, cracking, dehydration, decarboxylation, carboxylation, amination, deamination, alkylation, dealkylation, oxidation, reduction, polymerization, and depolymerization.

A chemical conversion system may comprise one or more electrochemical reduction units (e.g., stacks). In some embodiments, a chemical conversion system comprises one stack. In some embodiments, a chemical conversion system comprises two or more stacks. In some embodiments, stacks are used to generate a RCP and/or upgrade a RCP. For example, in a system comprising one stack. RCPs may be generated in the stack while a voltage is applied, and at least a portion of the RCPs may be recirculated back to the stack for upgrading (e.g., into larger RCPs). In another example, in a system comprising two stacks. RCPs may be generated in a first stack and at least a portion of the RCPs may be directed to a second stack for upgrading (e.g., into larger RCPs).

In the electrochemical reduction of CO₂, various reduced carbon products (“RCPs”) may be generated, including but not limited to C1-C40 alcohols, aldehydes, ketones, and linear, branched, and cyclic alkanes and alkenes. In some cases, allowing these reduced carbon products to be retained within the electrochemical reactor may allow for their enlargement, such that further carbon, hydrogen, and in some cases oxygen atoms are added to them, along with electrons, increasing their size and energy and changing their combustion characteristics. For example, ethanol may be produced as an initial RCP of a CO₂ reduction reaction. By remaining in the electrochemical stack for a longer period of time (e.g., in a taller stack or in a wider stack), the ethanol may act as a reactant for further reduction reactions (such as ethanol to butanol), thereby producing a larger, upgraded RCP. In some embodiments, an upgraded RCP is a carbon product that comprises at least one additional carbon atom, hydrogen atom, or oxygen atom, or combination thereof from the corresponding, original RCP (e.g., parent RCP). In some embodiments, an upgraded RCP comprises at least one additional carbon atom from the corresponding original RCP. For example, an upgraded RCP may be dodecane, while the original RCP is butane. In some embodiments, an upgraded RCP comprises at least one additional oxygen atom from the corresponding original RCP. For example, an upgraded RCP may be a C12 ketone, while the original RCP is a C10 alkene.

In some instances, upgrading RCPs comprises introducing additional oxygen to the RCP (e.g., hydroxyl group). In some embodiments, an increased number of oxygen atoms in an RCP correlates to a greater insolubility of the RCP in an aqueous phase.

In some embodiments, upgrading comprises oligomerization of two or more RCPs. For example, two C₂ RCPs may react during a upgrading process to yield a C4 RCP. In some embodiments, upgrading comprises reacting with additional electrolyte (e.g., bicarbonate). For example, a C₃ RCP may react with bicarbonate in an electrochemical stack during an upgrading process to yield a C₄ RCP.

In some cases, reduced carbon products may be separated from the electrolyte stream and introduced into a separate electrochemical reactor where they may undergo further reduction which may allow for their enlargement, such that further carbon, hydrogen, and in some cases oxygen atoms are added to them, along with electrons, increasing their size and energy and changing their combustion characteristics. For example, ethanol may be produced as an initial RCP of a CO₂ reduction reaction, be directed to a second, separate electrochemical reactor which may comprise an electrochemical stack, and be further reduced to butanol, thereby producing a larger RCP. For example, a mixture of C1-C15 RCPs may be produced in a first stack, where RCPs comprising 6 carbon atoms or more may be separated from the mixture through a micro- or nanostructured membrane (e.g., a membrane comprising carbon nanotubes), and RCPs comprising 5 carbon atoms or less may be directed to a second stack (or recirculated back to the first stack) for further reacting and upgrading.

In some embodiments, a RCP may comprise a molar heat of combustion at 298K and constant pressure of at least about −15,000 kilojoules per mol (kJ/mol), −14,000 kJ/mol, −13,000 kJ/mol, −12,000 kJ/mol, −11,000 kJ/mol, −10,000 kJ/mol, −9,000 kJ/mol, −8,000 kJ/mol, −7,000 kJ/mol, −6,000 kJ/mol, −5,000 kJ/mol, −4,000 kJ/mol, −3,000 kJ/mol, −2,000 kJ/mol, −1000 kJ/mol, −900 kJ/mol, −800 kJ/mol, −700 kJ/mol, −600 kJ/mol, −500 kJ/mol, −400 kJ/mol, −300 kJ/mol, −200 kJ/mol, −100 kJ/mol or less. In some embodiments, an upgraded RCP may comprise a molar heat of combustion at 298K and constant pressure of at least about −15,000 kilojoules per mol (kJ/mol), −14,000 kJ/mol, −13,000 kJ/mol, −12,000 kJ/mol, −11,000 kJ/mol, −10,000 kJ/mol, −9,000 kJ/mol, −8,000 kJ/mol, −7,000 kJ/mol, −6,000 kJ/mol, −5,000 kJ/mol, −4,000 kJ/mol, −3,000 kJ/mol, −2,000 kJ/mol, −1000 kJ/mol, −900 kJ/mol, −800 kJ/mol, −700 kJ/mol, −600 kJ/mol, −500 kJ/mol, −400 kJ/mol, −300 kJ/mol, −200 kJ/mol, −100 kJ/mol or less.

In some embodiments, a RCP may comprise a molar heat of combustion that is more than (e.g., less negative than) the molar heat of combustion of an upgraded RCP. For example, if the molar heat of combustion is about −1,000 kJ/mol of a RCP, then the heat of combustion for a corresponding upgraded RCP will be less than −1,000 kJ/mol (e.g., <−1,000 kJ/mol).

The residence time of a RCP in an electrochemical reduction system may affect the size (e.g., molar weight) of the RCP. In some embodiments, the residence time of a RCP in a stack is determined as a factor of the dimension of the stack. In some embodiments, a taller (vertical height) electrochemical reduction stack results in longer residence times, compared to a relatively shorter stack. In some embodiments, a shorter (vertical height) electrochemical reduction stack results in shorter residence times, compared to a relatively taller stack. In some embodiments, a wider (horizontal) electrochemical reduction stack results in a longer residence time, compared to a relatively narrower stack. In some embodiments, a narrower (horizontal) electrochemical reduction stack results in a shorter residence time, compared to a relatively wider stack.

Depending on the objective of operating the electrochemical reduction system, it may be desirable to have a RCP reside within the electrochemical reduction system for short or long periods of time. For example, a goal may be to separate the RCPs in a vapor phase, so a shorter residence time will suffice in order to yield smaller RCPs (e.g., less than 6 carbons) that may easily be vaporized. On the other hand, for example, a goal may be to yield RCPs with higher energy density (e.g., for increased compatibility with engines designed to run on diesel or jet fuel), so a longer residence time in the electrochemical reduction system is required to yield the longer carbon chain (e.g., higher molecular weight) RCPs. In some embodiments, a longer residence time may be completed in a single electrochemical reduction unit. In some embodiments, a longer residence time may be completed in two or more electrochemical reduction units. For example, a RCP may be produced in a first electrochemical reduction unit (e.g., stack) in a fixed amount of time and directed to a second electrochemical reduction unit for further reduction in an additional fixed amount of time. The second electrochemical reduction unit may be referred to as a second electrochemical stack, upgrading stack, oligomerization stack, or cyclization stack herein. The fixed amount of time may be the same or different.

There may be opposing objectives in operating a CO₂ electrochemical reduction system with respect to the size and residence time of RCPs. On one hand, it may be desirable to separate the reduced carbon products in the vapor phase, which operates best on smaller carbon products, for example on RCPs that have less than 6 carbon atoms. However, it can be desirable to produce longer carbon chain products (“upgraded” RCPs) due to their increased energy density and increased compatibility with engines designed to run on diesel or jet fuels, for example.

It may be particularly useful to remove, or separate out, RCPs continuously while operating an integrated direct air capture (DAC) and electrochemical stack system. Continuously separating and removing RCPs during operation may allow for a minimal number of RCPs to remain in the stream that is directed back to the DAC unit, a minimal number of RCPs that are vaporized and lost to the air during additional capture of CO₂, and may allow for yielding larger (e.g., higher molecular weight) RCPs through additional electrochemical reduction. Disclosed herein are systems and methods for continuously removing (or separating) RCPs in order to minimize the number of RCPs lost to the air while also producing larger RCPs.

In some embodiments, one or more parameters of an electrochemical stack system may be adjusted for upgrading RCPs. In some embodiments, pH, total inorganic carbon (TIC), flow rate of electrolyte solution (with dissolved CO₂), stack dimension, catalyst design, or a combination thereof are adjusted to yield an RCP of a desired size.

In some embodiments, the pH of the stack, the TIC in a stack, the flow of electrolyte in a stack, the stack dimension, or catalyst design are adjusted to yield an RCP of a desired size. In some embodiments, at least two of the following parameters are adjusted to yield an RCP of a desired size: pH of the stack. TIC in a stack, the flow of electrolyte in a stack, the stack dimension, and catalyst design In some embodiments, at least three of the following parameters are adjusted to yield an RCP of a desired size: pH of the stack. TIC in a stack, the flow of electrolyte in a stack, the stack dimension, and catalyst design. In some embodiments, all of the following parameters are adjusted to yield an RCP of a desired size: pH of the stack. TIC in a stack, the flow of electrolyte in a stack, the stack dimension, and catalyst design. In some embodiments, not adjusting any parameter of a stack may not lead to further upgrading of a RCP. For example, circulating ethanol (e.g., C2 alcohol) produced as a RCP back to the same stack or to a different stack with identical conditions may only yield ethanol.

The pH of an electrochemical stack can be adjusted or selected to tune the identity or molecular weight of an RCP. The pH of a stack can be adjusted by adding acidic solution or basic solution to the stack. The pH of a stack can be adjusted by adding or subtracting electrolyte solution from a stack. In some embodiments, an electrochemical stack is operated at a pH of about 10 to about 15. In some embodiments, an electrochemical stack is operated at a pH of about 10, about 11, about 12, about 13, about 14, or about 15. In some embodiments, an electrochemical stack is operated at a pH of at least 10. The specific pH may be selected to tune the identity or molecular weight of an RCP. For example, a stack operated at a higher pH may yield an RCP with a greater amount of carbons as compared to a stack with a relatively lower pH. Operating the pH of a stack at an increased pH, either individually or in conjunction with adjusting at least one other parameter of the stack, may result in an upgraded RCP (or an RCP with greater than 12 carbon atoms, for example).

In some embodiments, the total inorganic carbon within an electrochemical stack may be selected to tune the identity or molecular weight of an RCP. In some cases, the TIC in an electrochemical stack is about 0.5 mol/L (M) to about 2.5 M. In some cases, the TIC in an electrochemical stack is about 0.5 M to about 1 M, about 0.5 M to about 1.25 M, about 0.5 M to about 1.5 M, about 0.5 M to about 1.75 M, about 0.5 M to about 2 M, about 0.5 M to about 2.5 M, about 1 M to about 1.25 M, about 1 M to about 1.5 M, about 1 M to about 1.75 M, about 1 M to about 2 M, about 1 M to about 2.5 M, about 1.25 M to about 1.5 M, about 1.25 M to about 1.75 M, about 1.25 M to about 2 M, about 1.25 M to about 2.5 M, about 1.5 M to about 1.75 M, about 1.5 M to about 2 M, about 1.5 M to about 2.5 M, about 1.75 M to about 2 M, about 1.75 M to about 2.5 M, or about 2 M to about 2.5 M. In some cases, the TIC in an electrochemical stack is about 0.5 M, about 1 M, about 1.25 M, about 1.5 M, about 1.75 M, about 2 M, or about 2.5 M. The specific pH may be selected to tune the identity or molecular weight of an RCP. In some cases, a stack operated with a higher TIC may yield an RCP with a greater amount of carbons as compared to a stack with a relatively lower TIC. Operating the pH of a stack at an increased TIC concentration, either individually or in conjunction with adjusting at least one other parameter of the stack, may result in an upgraded RCP (or an RCP with greater than 12 carbon atoms, for example). In some embodiments, the flow rate or flow profile of the electrolyte solution or other fluids throughout an electrochemical stack is reduced to eliminate turbulent flow. In some cases, an electrolyte solution has a laminar flow profile within an electrochemical stack. In some cases, flow of the electrolyte solution throughout the electrochemical stack is characterized by a Reynolds' number of about 500 to about 3,000. In some cases, flow of the electrolyte solution throughout the electrochemical stack is characterized by a Reynolds' number of about 500 to about 1.000, about 500 to about 1,500, about 500 to about 2,000, about 500 to about 2,500, about 500 to about 3,000, about 1,000 to about 1,500, about 1,000 to about 2,000, about 1,000 to about 2,500, about 1,000 to about 3,000, about 1,500 to about 2,000, about 1,500 to about 2,500, about 1,500 to about 3,000, about 2,000 to about 2,500), about 2,000 to about 3,000, or about 2,500 to about 3,000. In some cases, flow of the electrolyte solution throughout the electrochemical stack is characterized by a Reynolds' number of about 500, about 1,000, about 1,500, about 2,000, about 2,500, or about 3,000. In some cases, flow of the electrolyte solution throughout the electrochemical stack is characterized by a Reynolds' number of at most about 1.000, about 1,500, about 2,000, about 2,500, or about 3,000. The flow rate or flow profile of the electrolyte solution or other fluids throughout the electrochemical stack may be selected to tune the identity or molecular weight of an RCP. In some cases, a stack operated with a lower flow rate or Reynolds' number may yield an RCP with a greater amount of carbons as compared to a stack with a relatively lower flow rate or Reynolds' number. In some instances, a laminar flow profile may increase the contact time of an RCP with a catalyst within the electrochemical stack, thus yielding an upgraded RCP. Operating the stack with a laminar flow profile, either individually or in conjunction with adjusting at least one other parameter of the stack, may result in an upgraded RCP (or an RCP with greater than 12 carbon atoms, for example).

In some embodiments, a catalyst is used within an electrochemical stack to facilitate reduction of CO₂ or upgrade RCPs. The identity or composition can be adjusted or selected to tune the identity or molecular weight of an RCP. For example, the size of a catalyst nanoparticle can be adjusted to increase the size of an RCP. In some cases, a catalyst comprises nanoparticles with a diameter of about 25 nm to about 100 nm. In some cases, a catalyst comprises nanoparticles with a diameter of about 25 nm to about 50 nm, about 25 nm to about 75 nm, about 25 nm to about 100 nm, about 50 nm to about 75 nm, about 50 nm to about 100 nm, or about 75 nm to about 100 nm. In some cases, a catalyst comprises nanoparticles with a diameter of about 25 nm, about 50 nm, about 75 nm, or about 100 nm. In some cases, a catalyst comprises nanoparticles with a diameter of at least about 25 nm, about 50 nm, or about 75 nm. In some cases, a catalyst comprises nanoparticles with a diameter of at most about 50 nm, about 75 nm, or about 100 nm. In some cases, a stack comprising a catalyst with larger nanoparticles may yield an RCP with a greater amount of carbons as compared to a stack comprising a catalyst with relatively smaller nanoparticles. Adjusting catalyst size, either individually or in conjunction with adjusting at least one other parameter of the stack, may result in an upgraded RCP (or an RCP with greater than 12 carbon atoms, for example).

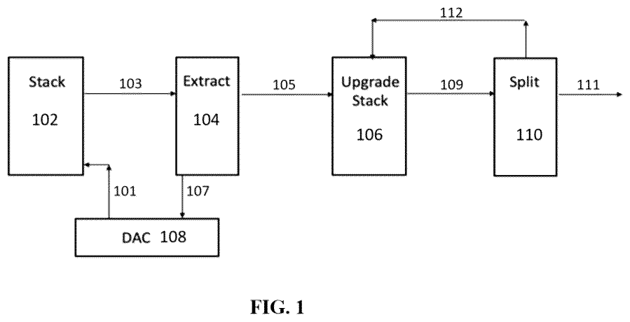

Various embodiments of a CO₂ reduction system capable of continuously removing RCPs while allowing for the production of larger sized carbon products are described herein. For example, referring to FIG. 1. RCPs can be generated in an electrochemical stack and removed from the electrolyte. RCPs can leave the stack by heat, gas stripping, adsorption, or a combination thereof prior to sending the depleted electrolyte back to the DAC system for further capture of CO₂. Removed RCPs may be present with some water (which was also removed from the electrolyte by the removal process) and can be directed to a second electrochemical stack for further reduction into larger RCPs. For example, the first electrochemical stack may mostly produce a mixture of C₁ to C₄ RCPs which may be further reduced to C₅ to C₁₆ RCPs in the second electrochemical stack.

In some instances, as depicted in FIG. 1, an electrolyte stream 107, containing an electrolyte solution (e.g., water) for use in an electrochemical CO₂ reduction process, may be contacted with a CO₂ containing gas in a direct air capture (DAC) unit 108 to produce a CO₂ enriched electrolyte. In some cases, the CO₂ enriched electrolyte contains bicarbonate. The CO₂ containing gas may be air from the atmosphere and directed into the DAC unit 108 through an inlet (not shown). In some instances, the pH, temperature, or other property of the electrolyte stream 107 may be controlled such to optimize capture of CO₂ from the CO₂ containing gas into the electrolyte solution. In some instances, the CO₂ containing gas also contains water which may also be absorbed by the electrolyte stream.

The CO₂-enriched electrolyte stream 101 may enter a first electrochemical stack 102. The electrochemical stack 102 may contain a cathode, an anode, and an ion-exchange membrane. Within the electrochemical stack, electrical energy (e.g., applied voltage) may cause the carbon in the electrolyte solution 101 to be reduced into one or more types of RCPs. The first electrochemical stack 102 may comprise a first catalyst. In some embodiments, the first catalyst comprises copper, defect-containing or doped carbon materials, silver palladium, or nickel, or any combination thereof. The RCPs produced in the first stack 102 may have less carbon atoms than RCPs produced in the second stack 106. Certain parameters of the first stack 102 can be tuned to produce RCPs of a smaller size as compared to the second electrochemical stack. Such parameters can include pH, total inorganic carbon, stack height, stack width, catalyst size, residence time, flow rate, or flow profile, or any combination thereof.

The RCP-enriched electrolyte stream 103 may be directed to an extraction or separation means 104. The extractor 104 may separate RCPs from the electrolyte solution. The RCPs may be removed from the electrolyte solution by heat stripping, gas stripping, or adsorption, or any combination thereof. The electrolyte solution, which may be depleted of RCPs (e.g., depleted electrolyte), may exit the extractor 104 as electrolyte stream 107 back into the DAC unit 108 for additional capture of CO₂, so it can be reused within the electrochemical reduction system as described herein. The electrolyte stream 107 may enter the DAC 108 where it can be used to capture additional CO₂. It may be particularly useful to remove RCPs continuously, such that none or very little RCPS remain in the electrolyte stream 107 that is directed to the DAC 108. This may prevent RCPs being lost to the air during direct air capture of CO₂. In some embodiments, the electrolyte stream exiting extractor 104 may not be reused within the electrochemical reduction system.

The reduced carbon products may exit the extractor 104 as RCP stream 105 and enter a second electrochemical stack (upgrade stack) 106. In some cases, the RCP stream 105 comprises RCPs that are present in water which may have been removed from the electrolyte solution in extractor 104. The second electrochemical stack 106 may be used to further reduce, or upgrade. RCPs into larger, reduced carbon products with higher molecular weights. The second electrochemical stack 106 may contain a a second cathode, a second anode, and a second membrane. The second electrochemical stack 106 may comprise a second catalyst. In some embodiments, the second catalyst comprises copper, defect-containing or doped carbon materials, silver palladium, or nickel, or any combination thereof. In some cases, the second catalyst comprises the same materials as the first catalyst. In some cases, the second catalyst comprises the same materials as the first catalyst but in a different proportion or amount. In some embodiments, the second catalyst acts to produce an upgraded set of RCPs that are larger (e.g., higher molecular weight) and/or cyclic. The second catalyst may comprise catalyst materials designed specifically to produce desired carbon products, such as branched or cyclic carbon molecules. Certain parameters of the second stack 106 can be tuned to produce RCPs of a larger size as compared to the first electrochemical stack. Such parameters can include pH, total inorganic carbon, stack height, stack width, catalyst size, residence time, flow rate, or flow profile, or any combination thereof.

The electrochemical reduction of RCPs in the second electrochemical stack 106 may take place in the liquid phase, gas phase, or a mixed phase. In some cases, the reduction reaction in the second electrochemical stack 106 takes place in the gas phase, utilizing humidified air comprising RCPs. In some cases, the reduction reaction in the second electrochemical stack 106 may be in the aqueous phase, utilizing an electrolyte. Hydrogen may be introduced into the second electrochemical stack 106. In some cases, the introduced hydrogen is produced in the first electrochemical stack 102 and directed to the second electrochemical stack 106. In some cases, the second electrochemical stack may be gas phase and may contain humidified air containing RCPs and/or hydrogen gas. The temperature of the second stack 106 may be higher or lower than the first stack 102, to facilitate the production of RCPs of a desired size.

The upgraded RCPs may exit the second electrochemical stack 106 as RCP stream 109 and enter a second separation unit 110. The second separation unit 110 may also be referred to as a split. Within the second separation unit 110, the upgraded RCPs may be separated based on their size. Larger RCPs (e.g., with a carbon number range from about C12, or more, for example) may be separated from smaller RCPs (e.g., with a carbon number range from about C₁ to about C₁₂, for example) by a variety of means, including vapor or pervaporation (PV) separation methods utilizing carbon nanotube (“CNT”) membranes, hydrocyclones, or adsorption separation, for example. The larger RCPs may be sparingly soluble or insoluble in water, and may have low vapor pressures, necessitating different separation methods than those that may be ideally used in the separation of RCPs produced in the first electrochemical stack. After separation, smaller (e.g., lower molecular weight) RCPs may exit the split 110 as stream 112 and reenter the second electrochemical stack 106 to be further reduced. RCPs with an increased carbon number may exit the split 110 as stream 111 and be used or sold as a finished product or undergo further processing. In some cases, the stream 111 can be sold or used as a finished fuel product, including diesel or jet fuel.

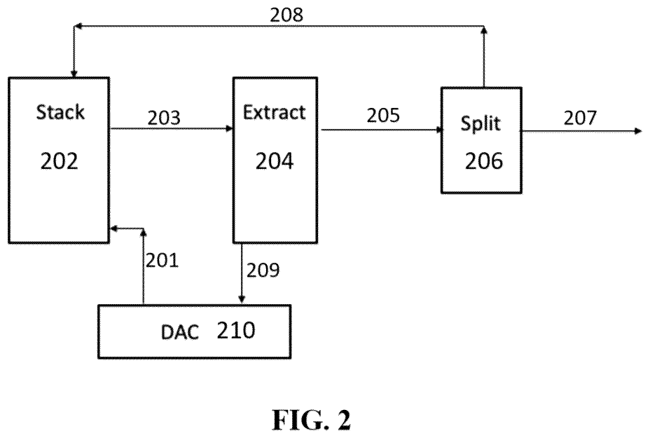

In some instances, as depicted in FIG. 2, an electrolyte stream 209, containing an electrolyte solution (e.g., water) for use in an electrochemical CO₂ reduction process, may be contacted with a CO₂ containing gas in a direct air capture (DAC) unit 210 to produce a CO₂ enriched electrolyte. In some cases, the CO₂ enriched electrolyte contains bicarbonate. The CO₂ containing gas may be air from the atmosphere and directed into the DAC units 210 through an inlet (not shown). In some instances, the temperature or other property of the electrolyte stream 209 may be controlled such to optimize capture of CO₂ from the CO₂ containing gas into the electrolyte solution. In some instances, the CO₂ containing gas also contains water which may also be absorbed by the electrolyte stream 209.

The CO₂-enriched electrolyte stream 201 may enter an electrochemical stack 202. The electrochemical stack 202 may contain a cathode, an anode, and a membrane, and within the electrochemical stack, electrical energy (e.g., applied voltage) may cause the carbon in the electrolyte solution 201 to be reduced into one or more types of RCPs. The residence time of the CO₂-enriched electrolyte stream within the electrochemical stack 202 may be increased in order to produce larger RCPs. For example, increasing residence time within the electrochemical stack may result in increased production of RCPs with a carbon number greater than C₁₂, for example. In some embodiments, one or more parameters of the electrochemical stack 202 may be adjusted for upgrading RCPs. In some embodiments, pH, total inorganic carbon (TIC), flow rate of electrolyte solution (with dissolved CO₂), stack dimension, catalyst design, or a combination thereof are adjusted to yield an RCP of a desired size.

In some cases, allowing RCPs to be retained within the electrochemical stack 202 may allow for their enlargement through the additional of carbon, hydrogen, and oxygen atoms. Enlarged RCPs may have different combustion characteristics as compared to their smaller counterparts. The electrochemical stack 202 may comprise a catalyst. In some embodiments, the first catalyst comprises copper, defect-containing or doped carbon materials, silver palladium, or nickel, or any combination thereof.

The RCP-enriched electrolyte stream 203 may be directed to an extractor or separation means 204. The extractor 204 may separate RCPs from the electrolyte solution. The RCPs may be removed from the electrolyte solution by heat stripping, gas stripping, or adsorption, or any combination thereof. The electrolyte solution, which may be depleted of RCPs (e.g., depleted electrolyte), may exit the extractor 204 as electrolyte stream 209 back into the DAC unit 210 for additional capture of CO₂, so it can be reused within the electrochemical reduction system as described herein. In some embodiments, the electrolyte stream exiting extractor 204 may not be reused within the electrochemical reduction system.

The RCPs may exit the extractor 204 as RCP stream 205 and enter a separation unit 206. The second separation unit 206 may also be referred to as a split. Within the separation unit 206. RCPs may be separated based on their size. Larger RCPs may be separated from smaller RCPs by a variety of means, including vapor or pervaporation separation methods utilizing carbon nanotube (“CNT”) membranes, hydrocyclones, or adsorption separation, for example. After separation, smaller (e.g., lower molecular weight) RCPs may exit the split 206 as stream 208 and reenter the electrochemical stack 102 to be further reduced. RCPs with an increased carbon number range may exit the split 206 as stream 207 and be used or sold as a finished product or undergo further processing. In some cases, the stream 207 can be sold or used as a finished fuel product, including diesel and jet fuel.

### Computer Systems

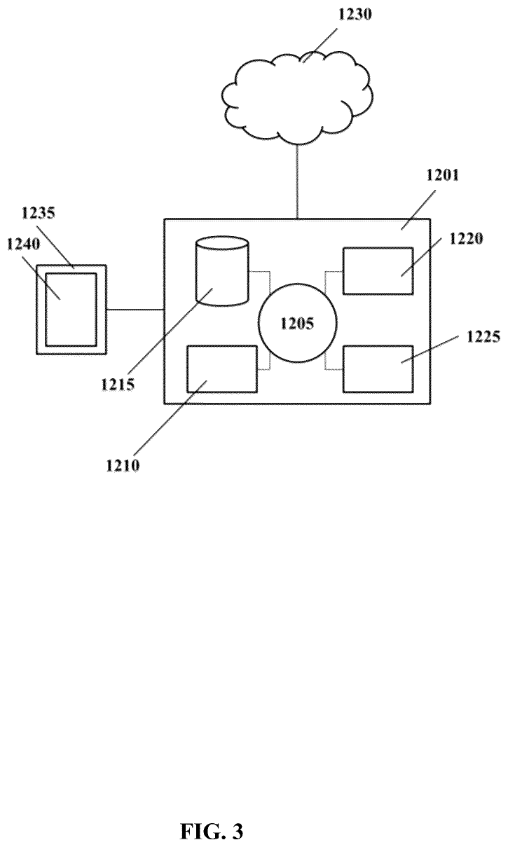

The present disclosure provides computer systems that are programmed to implement methods of the disclosure. FIG. 3 shows a computer control system 1201 that is programmed or otherwise configured to control a chemical reduction system or a process within a chemical reduction system (e.g., controlling the pH within an electrochemical stack, controlling the flow rate of an electrolyte). The computer control system 1201 can regulate various aspects of the methods of the present disclosure, such as, for example, methods of producing a reduced carbon product or monitoring for potentially hazardous operating conditions. The computer control system 1201 can be implemented on an electronic device of a user or a computer system that is remotely located with respect to the electronic device. The electronic device can be a mobile electronic device.

The computer system 1201 includes a central processing unit (CPU, also “processor” and “computer processor” herein) 1205, which can be a single core or multi core processor, or a plurality of processors for parallel processing. The computer system 1201 also includes memory or memory location 1210 (e.g., random-access memory, read-only memory, flash memory), electronic storage unit 1215 (e.g., hard disk), communication interface 1220 (e.g., network adapter) for communicating with one or more other systems, and peripheral devices 1225, such as cache, other memory, data storage and/or electronic display adapters. The memory 1210, storage unit 1215, interface 1220 and peripheral devices 1225 are in communication with the CPU 1205 through a communication bus (solid lines), such as a motherboard. The storage unit 1215 can be a data storage unit (or data repository) for storing data. The computer system 1201 can be operatively coupled to a computer network (“network”) 1230 with the aid of the communication interface 1220. The network 1230 can be the Internet, an internet and/or extranet, or an intranet and/or extranet that is in communication with the Internet. The network 1230 in some cases is a telecommunication and/or data network. The network 1230 can include one or more computer servers, which can enable distributed computing, such as cloud computing. The network 1230, in some cases with the aid of the computer system 1201, can implement a peer-to-peer network, which may enable devices coupled to the computer system 1201 to behave as a client or a server.

The CPU 1205 can execute a sequence of machine-readable instructions, which can be embodied in a program or software. The instructions may be stored in a memory location, such as the memory 1210. The instructions can be directed to the CPU 1205, which can subsequently program or otherwise configure the CPU 1205 to implement methods of the present disclosure. Examples of operations performed by the CPU 1205 can include fetch, decode, execute, and writeback.

The CPU 1205 can be part of a circuit, such as an integrated circuit. One or more other components of the system 1201 can be included in the circuit. In some cases, the circuit is an application specific integrated circuit (ASIC).

The storage unit 1215 can store files, such as drivers, libraries and saved programs. The storage unit 1215 can store user data, e.g., user preferences and user programs. The computer system 1201 in some cases can include one or more additional data storage units that are external to the computer system 1201, such as located on a remote server that is in communication with the computer system 1201 through an intranet or the Internet.

The computer system 1201 can communicate with one or more remote computer systems through the network 1230. For instance, the computer system 1201 can communicate with a remote computer system of a user (e.g., a user monitoring the pH and temperature of an electrolyte stream). Examples of remote computer systems include personal computers (e.g., portable PC), slate or tablet PC's (e.g., Apple® iPad, Samsung® Galaxy Tab), telephones. Smart phones (e.g., Apple® iPhone, Android-enabled device. Blackberry®), or personal digital assistants. The user can access the computer system 1201 via the network 1230.

Methods as described herein can be implemented by way of machine (e.g., computer processor) executable code stored on an electronic storage location of the computer system 1201, such as, for example, on the memory 1210 or electronic storage unit 1215. The machine executable or machine readable code can be provided in the form of software. During use, the code can be executed by the processor 1205. In some cases, the code can be retrieved from the storage unit 1215 and stored on the memory 1210 for ready access by the processor 1205. In some situations, the electronic storage unit 1215 can be precluded, and machine-executable instructions are stored on memory 1210.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 1201, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory, cloud) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc, shown in the drawings. Volatile storage media include dynamic memory, such as main memory of such a computer platform.

Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1201 can include or be in communication with an electronic display 1235 that comprises a user interface (UI) 1240 for providing, for example, the pH, flow rates, or temperature of electrolyte streams. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 1205. The algorithm can, for example, regulate the flow rate of a gas stream comprising CO₂ through a direct air capture unit to optimize capture of CO₂ by an electrolyte solution. As another example, the algorithm can regulate the electric field applied to a micro- or nanostructured membrane to control the selectivity of the membrane for a particular chemical species.

Methods and systems of the present disclosure may be combined with or modified by other methods and systems, such as, for example, those disclosed in U.S. Pat. No. 10,590,548 and WO/2020/131837, each of which is entirely incorporated herein by reference.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. The section headings used herein are for organizational purposes only and are not to be construed as limiting the subject matter described. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for reduced carbon product generation, comprising:
(a) contacting a gas stream with an electrolyte solution, wherein said gas stream comprises carbon dioxide (CO₂), thereby capturing said CO₂ from said gas stream into said electrolyte solution;
(b) reducing said CO₂ in said electrolyte solution to generate a first reduced carbon product; and
(c) reducing a subset of said first reduced carbon product to generate a second reduced carbon product, wherein said second reduced carbon product comprises a greater number of carbon atoms than said first reduced carbon product.

2. The method of claim 1, wherein (b) comprises using an electrochemical stack to reduce said CO₂ to generate said first reduced carbon product.

3. The method of claim 2, wherein (c) comprises using said electrochemical stack to reduce said subset of said first reduced carbon product to generate said second reduced carbon product.

4. The method of claim 3, wherein said electrochemical stack further comprises a carbon nanotube (CNT) membrane.

5. The method of claim 3, further comprising removing an additional subset of said first reduced carbon product from said electrochemical stack.

6. The method of claim 5, further comprising recycling at least a portion of said additional subset of said first reduced carbon product to said electrochemical stack.

7. The method of claim 3, further comprising controlling one or more parameters of said electrochemical stack to facilitate or increase generation of said second reduced carbon product in (c).

8. The method of claim 7, wherein said one or more parameters comprises a pH of said electrochemical stack.

9. The method of claim 8, wherein said pH of said electrochemical stack is greater than 10.

10. The method of claim 7, wherein said one or more parameters comprises a concentration of total inorganic carbon (TIC) in said electrochemical stack.

11. The method of claim 10, wherein said concentration of said TIC in said electrochemical stack is greater than 0.5 mol/L (M).

12. The method of claim 7, wherein said one or more parameters comprises a flow profile or flow rate of said electrolyte solution through said electrochemical stack.

13. The method of claim 12, wherein said flow profile of said electrolyte solution comprises laminar flow, and wherein said laminar flow has a Reynolds' number of less than 2000.

14. The method of claim 7, wherein said electrochemical stack comprises a catalyst, and wherein one or more parameters comprises a particle size of said catalyst.

15. The method of claim 14, wherein said particle size of said catalyst is greater than 25 nanometers (nm).

16. The method of claim 7, wherein said one or more parameters comprises a residence time of said electrolyte solution in said electrochemical stack.

17. The method of claim 2, wherein (c) comprises using an additional electrochemical stack separate from said electrochemical stack to reduce said first reduced carbon product to generate said second reduced carbon product.

18. The method of claim 17, further comprising: (a) controlling a first set of parameters of said electrochemical stack to facilitate or increase generation of said first reduced carbon product in said electrochemical stack, and (b) controlling a second set of parameters of said additional electrochemical stack to facilitate or increase generation of said second reduced carbon product in said additional electrochemical stack.

19. The method of claim 17, wherein said electrochemical stack is operated at a lower pH than said additional electrochemical stack.

20. The method of claim 17, wherein said electrochemical stack has a lower total inorganic carbon (TIC) concentration than said additional electrochemical stack.

21. The method of claim 17, wherein said electrolyte solution in said electrochemical stack has a lower Reynolds' number than said electrolyte solution in said additional electrochemical stack.

22. The method of claim 17, wherein said additional electrochemical stack is taller than said electrochemical stack.

23. The method of claim 17 wherein said additional electrochemical stack is wider than said electrochemical stack.

24. The method of claim 17, wherein said electrochemical stack comprises a first catalyst, and wherein said additional electrochemical stack comprises a second catalyst, and wherein a particle size of said second catalyst is larger than said first catalyst.

25. The method of claim 17, wherein a residence time of said electrolyte solution in said electrochemical stack is less than a residence time of said electrolyte solution in said additional electrochemical stack.
